(19) United States
(12) Patent Application Publication
(10) Pub. No.: US 2013/0119864 A1
(43) Pub. Date: May 16, 2013

(54) METHOD FOR OBTAINING HIGH-ENERGY REPETITIVELY PULSED PLASMA FLOWS IN GASES AT ATMOSPHERIC AND HIGH PRESSURE

(71) Applicant: Yuri Aleksandrovich Chivel, Minsk (BY)

(72) Inventor: Yuri Aleksandrovich Chivel, Minsk (BY)

(21) Appl. No.: 13/811,369

(22) PCT Filed: Jul. 11, 2011
(86) PCT No.: PCT/IB2011/002838

§ 371 Date: Jan. 26, 2013

(30) Foreign Application Priority Data
Jul. 19, 2010 (RU) 2010130150

(51) Int. Cl. H05H 1/24

(52) U.S. Cl. CPC H05H 1/24
USPC 315/111.21

(57) ABSTRACT

Method for obtaining high-energy repetitively pulsed plasma flows in gases at atmospheric and high pressure.

The invention relates to the field of plasma physics and plasma technology and can be used in the design and creation of sources of high plasma flows for scientific and technological applications.

A method of producing high-energy repetitively pulsed plasma flows in the atmospheric gases and high pressure gases, is to create a plasma current shell in the channel of the plasma accelerator and its electrodynamic acceleration.

New in the author's opinion is that the area of low gas density is created in the acceleration channel with a high degree of ionization in the region of the plasma current shell formation.

The invention relates to the field of plasma physics and plasma technology and can be used in the design and creation of sources of high plasma flows for scientific and technological applications.

There is a method [1] of obtaining high-pulsed plasma flows in the high-pressure gases, in which at the channel of coaxial plasma accelerator, the accelerated plasma current shell is formed using electric discharge between the electrodes, The disadvantage of this method is the strong irregularity of the parameters of the plasma shell around the perimeter of the channel and hence a low coefficient of conversion of electrical energy into kinetic energy of the plasma current shell and the high noise level at operation of the accelerator.

Closest to the proposed method is presented in [2] method for high repetitively pulsed plasma flows formation in gases at atmospheric pressure, in which using a repetitively pulsed detonation device low ionized gas is injected into accelerator channel in which is accelerated. The disadvantage of this method is the complexity of the extremely high level of noise when triggered detonation unit (up to 200 dB) and environmental hazards.

The objective of the claimed invention is to provide a clean and highly efficient method for producing high-energy repetitively pulsed plasma flows in the atmospheric gases and high pressure gases. To solve this problem a method for making high repetitively pulsed plasma flows in a gas at atmospheric pressure and high pressure gas, which consists in the creation of the plasma current shell in a plasma accelerator channel and its electrodynamic acceleration

New in the author's opinion is that the area of low gas density is created in the acceleration channel with a high degree of ionization in the region of the plasma current shell formation.

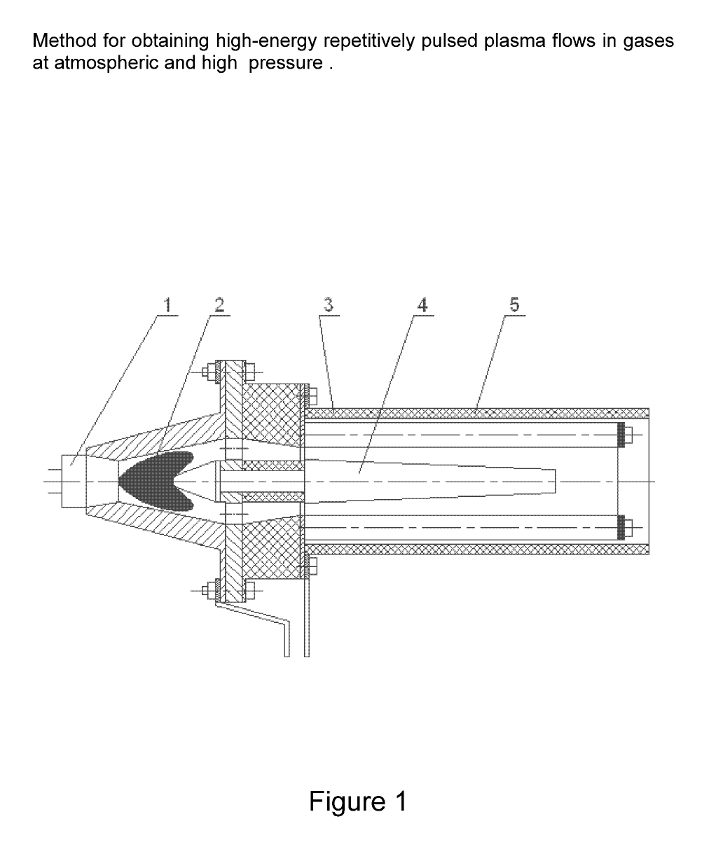

The essence of the proposed method is illustrated drawing (FIG. 1), where 1—DC plasma source, 2—DC plasma, 3—anode 4—cathode, 5—dielectric screen.

Using an external DC gas-plasma source 2 with plasma temperature 3000-6000 K at atmospheric pressure the gaseous medium with lower density (10 and more times) in the plasma accelerator channel is formed. The coaxial accelerating channel is formed by the anode electrode 3 (in this design is a set of rods) and the cathode 4. Screen 5 limits a spreading of gas. In the breakdown of the gas gap anode-cathode plasma current shell is created, The resulting plasma current shell is accelerated by the Lorentz force along the axis of the acceleration channel.

Reduction in the density of gas at the same time increasing ionization provides a reduction in the breakdown voltage and the soft nature of the formation of a homogeneous across perimeter plasma current shell. This dramatically reduces the noise level (less than 90 dB), and the gradual increase of the gas density along the length of the acceleration channel creates conditions for smooth acceleration shell with smooth increase involved in the movement of the mass of gas. The homogeneity of the plasma current shell along the perimeter of the acceleration channel provides high conversion of electrical energy into kinetic energy of the plasma shell and of gas which involved in the movement.

Experimentally shown that the proposed method allows to obtain the plasma flows in the air at atmospheric pressure with the following parameters: the plasma temperature 10-15×10³ K, flow rate −1.8 km/s at the section of the flow up to 2-3 cm in diameter.

### REFERENCES

1. Lebedev A D Apricot B A.//Pulsed plasma accelerators of high pressure. Novosibirsk in 1990. 290C.
2. Yu. N. Tyurin Pulsed-plasma treatment [Text]/N. Turin//Automatic Welding”, 2001., No 1, p. 38-44.

1. A method for obtaining high-energy repetitively pulsed plasma flows in the atmospheric gases and high pressure gases, which consists in the creation of the plasma current shell in a plasma accelerator channel and its electrodynamic acceleration, wherein area of low gas density is created in the acceleration channel with a high degree of ionization in the region of the plasma current shell formation.
